(19) United States
(12) Patent Application Publication
(10) Pub. No.: US 2017/0161692 A1
(43) Pub. Date: Jun. 8, 2017

(54) PROVIDING REMINDERS RELATED TO CONTEXTUAL DATA ON LOCK SCREENS

(71) Applicant: MICROSOFT TECHNOLOGY LICENSING, LLC, Redmond, WA (US)

(72) Inventors: Robert Miller, Bellevue, WA (US); March Rogers, Redmond, WA (US)

(21) Appl. No.: 14/960,455

(22) Filed: Dec. 7, 2015

(51) Int. Cl. G06Q 10/10; G06F 17/24; G06F 17/27; G06F 3/16; H04W 4/02; H04M 1/725

(52) U.S. Cl. CPC G06Q 10/1097; H04W 4/02; H04M 1/72519; G06F 17/2705; G06F 3/16; G06F 17/24

(57) ABSTRACT

A reminder related to contextual data on a lock screen may be provided. In some examples, a communication application receives contextual data of a participant from a source associated with the participant. Next, the contextual data is analyzed to detect an upcoming task associated with the participant. A reminder based on the upcoming task is generated and presented. After detecting a modification to the reminder, the modification is saved at an isolated destination.

### BACKGROUND

Mobile devices, such as cell phones and handheld game consoles, include touch screens. The mobile devices accept an input by detecting movements, known as touch gestures, of objects in contact with the touch screen. Upon detection of a touch gesture, the mobile device, or an application stored on the mobile device, may execute an action. Some mobile devices may include lock screens to prevent unauthorized or unintentional access to the mobile device. The lock screen may regulate access to the mobile device by requiring performance of an action in order to receive access to the mobile device. Once the device is unlocked, a participant can execute a functionality associated with the mobile device.

In examples, the participant may forget to draft a note/a reminder to perform a task. Certain applications on the mobile device may display a reminder notification of an upcoming deadline to perform the task. However, the reminder notification may only be visualized once the screen is unlocked.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing a reminder related to contextual data on a lock screen. In some examples, a communication application may receive contextual data of a participant from a source associated with the participant. In response, the contextual data may be analyzed to detect an upcoming task associated with the participant. The communication application may generate the reminder associated with the upcoming task and may present the reminder. The task management application may detect a modification to the reminder. The modification to the reminder may be saved at an isolated destination.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating a method for providing a reminder related to contextual data on a lock screen, according to embodiments;

FIG. 2 is a conceptual diagram illustrating components of a scheme for receiving contextual data of a participant from a source associated with the participant, according to embodiments;

FIG. 3 is a block diagram illustrating example interactions between components of a system for providing a reminder related to contextual data on a lock screen, according to embodiments;

FIG. 4 is a conceptual diagram of a process for detecting a modification to a reminder related to contextual data on a lock screen, according to embodiments;

FIG. 5 is a networked environment, where a system according to embodiments may be implemented;

FIG. 6 is a block diagram of an example computing environment for providing a reminder related to contextual data on a lock screen, where embodiments may be implemented; and

FIG. 7 illustrates a logic flow diagram for providing a reminder related to contextual data on a lock screen, according to embodiments.

### DETAILED DESCRIPTION

As briefly described above, a reminder related to contextual data on a lock screen may be provided. In some examples, a communication application may receive contextual data of a participant from a source associated with the participant. The source may include a directory service, an online service, and/or a local data source, among others. Next, the contextual data may be analyzed to detect an upcoming task associated with the participant. The upcoming task may be used to generate a reminder.

The reminder may be presented. The reminder may include a textual reminder, an audio reminder, a graphical reminder, and/or a feedback reminder, among others. Next, a modification to the reminder may be detected and saved at a destination. The destination may include an isolated destination to prevent execution of a malicious code associated with the reminder or the modification. Furthermore, the reminder may be parsed to detect attributes associated with the reminder.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing a reminder related to contextual data on a lock screen. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and one or more processors that includes a server, a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. Actions or operations described herein may be executed on a single processor, on multiple processors (in a single machine or distributed over multiple machines), or on one or more cores of a multi-core processor. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that allow the application or service to interact or communicate with one or more other applications and services managed by separate entities.

While example implementations are described using communications herein, embodiments are not limited to communications. Providing a reminder related to contextual data on a lock screen may be implemented in other environments, such as instant messages, data sharing, application sharing, and similar communications, where contextual data and reminder data may be exchanged.

The technical advantages of providing a reminder related to contextual data on a lock screen may include, among others, an increased efficiency associated with participant interactions with a computing device. Processing and network bandwidth may be reduced because the communication application may automate reminder creation based on contextual data analysis associated with the participant. Further, by decreasing a number of actions performed on the computing device to capture and save reminders at a location, memory and processor burden may be reduced.

Embodiments address a need that arises from very large scale of operations created by networked computing and cloud based services that cannot be managed by humans. The actions/operations described herein are not a mere use of a computer, but address results of a system that is a direct consequence of software used as a service such as communication services offered in conjunction with the communications.

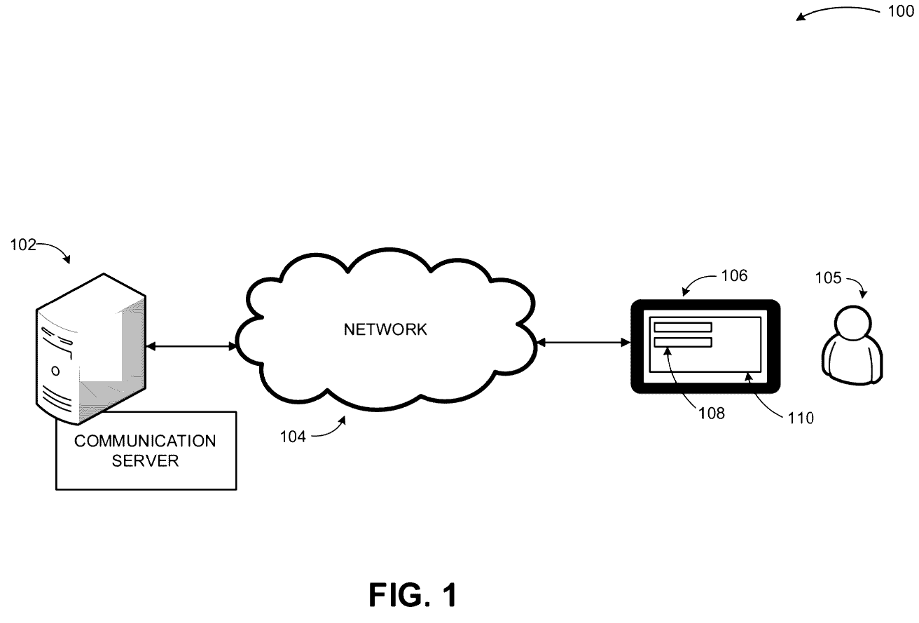

FIG. 1 is a conceptual diagram illustrating a method for providing a reminder related to contextual data on a lock screen, according to embodiments.

As shown in a diagram 100, a computing device 106 may execute a communication application 108. The computing device 106 may be a special purpose device that executes the communication application 108 to analyze contextual data received from a source and associated with a participant 105. The communication application 108 may detect an upcoming task associated with the participant 105 and may generate a reminder. The computing device 106 may include components such as processor(s), a display device 110, and/or a storage device, among others.

Components of the communication application 108 (such as a communication user interface (UI)) may be displayed on the display device 110 associated with the computing device 106. An example of the display device 110 may include a hardware screen that may be communicatively coupled to the computing device 106. The display device 110 may include a touch-based device that may detect gestures. The display device 110 may also provide feedback in response to the detected gestures (or any other form of input). Furthermore, the computing device 106 may include a desktop computer, a laptop computer, a tablet, a smart phone, and a wearable computer, among other similar computing devices, for example.

In some examples, the communication application 108 may be executed on a communication server 102. The communication server 102 may include a web server, a management server, and/or a document server, among others. The computing device 106 may communicate with the communication server 102 through a network 104. The network 104 may provide wired or wireless communications between nodes, such as the computing device 106 or the communication server 102.

The communication application 108 may receive contextual data of the participant 105 from the source associated with the participant 105. In response, the contextual data may be analyzed to detect the upcoming task associated with the participant 105. Then, the communication application 108 may generate the reminder associated with the upcoming task. Next, the communication application 108 may present, on the display device 110, the reminder.

While the example system in FIG. 1 has been described with specific components such as the communication server 102 and similar devices, embodiments are not limited to these components or system configurations and can be implemented with other system configuration employing fewer or additional components. Functionality for systems providing a reminder related to contextual data on a lock screen may also be distributed among the components of the systems differently depending on component capabilities and system configurations. Furthermore, embodiments are not limited to the approaches discussed herein, as the approaches may be applied to any data exchange in a networked communication environment using the principles described herein.

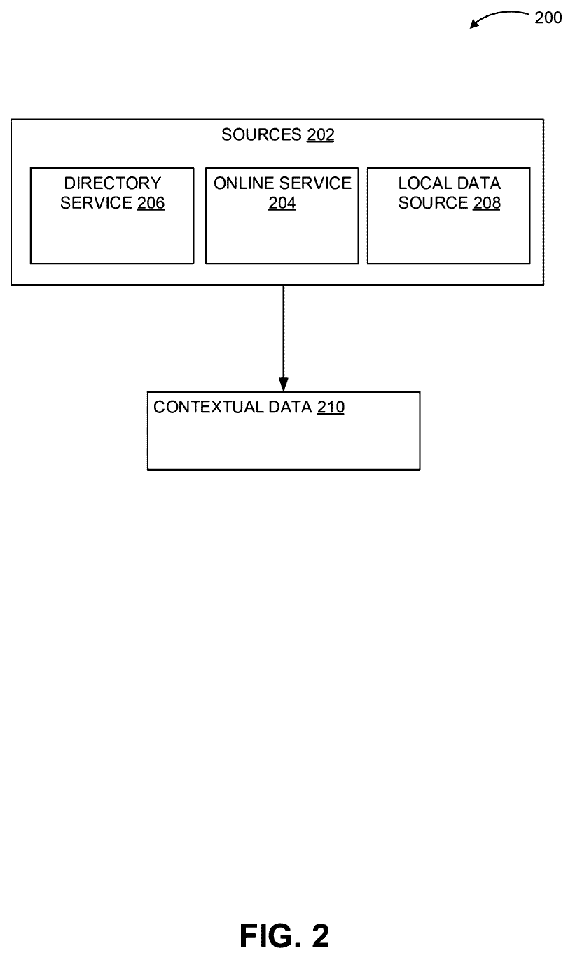

FIG. 2 is a conceptual diagram illustrating components of a scheme for receiving contextual data of a participant from a source associated with the participant, according to embodiments.

In a diagram 200, a computing device may execute a communication application. The computing device may include components such as processor(s), a display device, and/or a storage device, among others. The communication application may include a behavioral engine and/or a rendering engine, among other engines. The behavioral engine of the communication application may receive contextual data 210 of a participant from sources 202 associated with the participant. The sources 202 may include a directory service 206, an online service 204, and/or a local data source 208, among others.

In some embodiments, the behavioral engine may receive the contextual data 210 that includes organizational relationships from the directory service 206. The organizational relationships may identify the participant as an employee of an organization, a manager of the organization, a supporter of the organization, or a member of the organization, among others. In other examples, the behavioral engine may receive the contextual data 210 that includes social networking information from the online service 204. The social networking information may include, among others, groups participated in by the participant and/or organizations supported by the participant. In further embodiments, the behavioral engine may receive the contextual data 210 that includes preferences from the local data source 208. The preferences may include a display capability, local endpoint resources (e.g., processors, memory, display drivers, graphics acceleration, etc.), and/or location of the participants, among others.

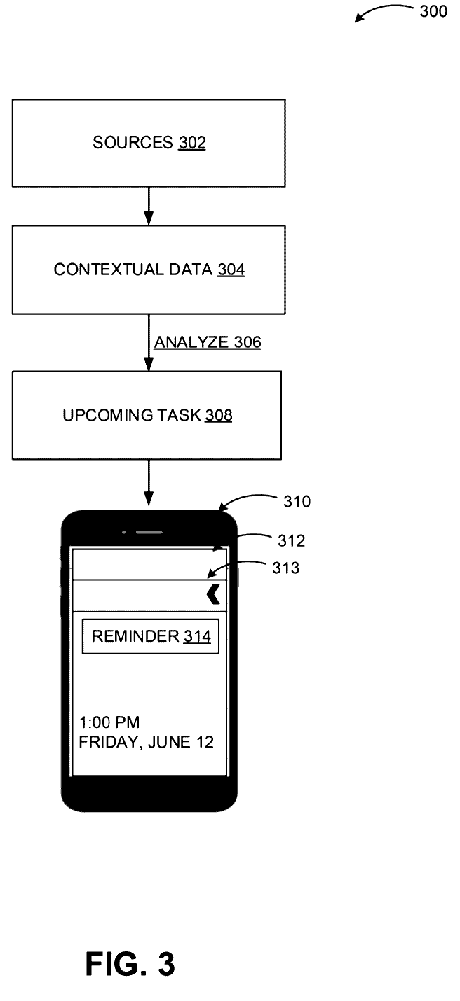

FIG. 3 is a block diagram illustrating example interactions between components of a system for providing a reminder related to contextual data on a lock screen, according to embodiments.

In a diagram 300, a computing device 310 may execute a communication application. The communication application may include a behavioral engine and/or a rendering engine, among other engines. The behavioral engine of the communication application may receive contextual data 304 of a participant from sources 302 associated with the participant. The behavioral engine may analyze 306 the contextual data 304 to detect an upcoming task 308 associated with the participant. The upcoming task 308 may include a deadline associated with a meeting, a deadline associated with an event, an upcoming presentation, and/or an upcoming meeting, among others.

In some embodiments, the behavioral engine may analyze 306 the contextual data 304 by extracting information from the contextual data 304. The information may include textual information and/or Global Positioning Service (GPS) location information, among other types of information. The behavioral engine may identify a priority value associated with the GPS location information and may identify another priority value associated with the textual information.

The behavioral engine may compare the priority value and the other priority value. In response to a determination that the priority value is larger than the other priority value, the behavioral engine may generate a reminder 314 based on the GPS location information associated with the priority value. In some embodiments, the behavioral engine may determine the other priority value as larger than the priority value. In response, the behavioral engine may generate the reminder 314 based on the textual information associated with the other priority value.

In other embodiments, the behavioral engine may analyze 306 the contextual data 304 by extracting information from the contextual data 304. The information may include audio information and/or graphical information, among other types of information. The behavioral engine may identify a priority value associated with the audio information and may identify another priority value associated with the graphical information.

The behavioral engine may compare the priority value and the other priority value. In response to a determination of the priority value being larger than the other priority value, the behavioral engine may generate the reminder 314 based on the audio information associated with the priority value. In some embodiments, the behavioral engine may determine the priority value as less than the priority value. In response, the behavioral engine may generate the reminder 314 based on the graphical information associated with the other priority value.

In other embodiments, the behavioral engine may generate the reminder 314 associated with the upcoming task 308. The reminder 314 may include a textual reminder, an audio reminder, a graphical reminder, and/or a feedback reminder, among other examples. The rendering engine of the communication application may present, on a display device 312 associated with the computing device 310, the reminder 314.

In some embodiments, the behavioral engine may display, on the display device 312, a deadline associated with the reminder 314. The deadline may be distinguished from the reminder 314 with a textual scheme, a graphical scheme, an audio scheme, an animation scheme, a coloring scheme, a highlighting scheme, and/or a shading scheme, among other schemes. In further embodiments, the behavioral engine may display, on the display device 312, a summary information of an attachment associated with the reminder 314. The summary information may include a sender of the attachment, a time received associated with the attachment, and/or a title of the attachment, among other information.

In other embodiments, the rendering engine of the communication application may detect a modification to the reminder 314 and may save the modification to the reminder 314 at a destination. The destination may include an isolated destination. In examples, the isolated destination may include a lock screen 313 of the computing device 310.

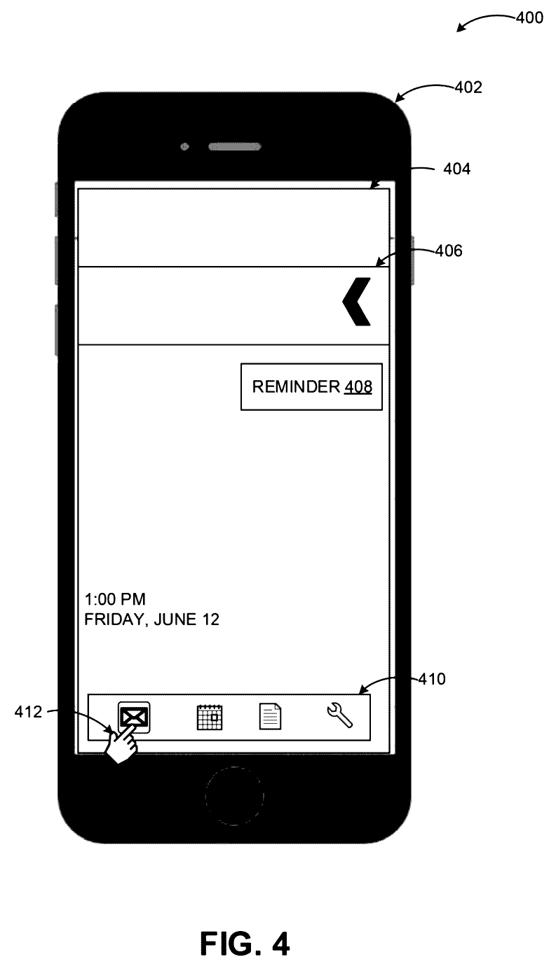

FIG. 4 is a conceptual diagram of a process for detecting a modification to a reminder related to contextual data on a lock screen, according to embodiments.

In a diagram 400, a computing device 402 may execute a communication application. The communication application may include a behavioral engine and/or a rendering engine, among other engines. The behavioral engine of the communication application may receive contextual data of a participant from sources associated with the participant and may analyze the contextual data to detect an upcoming task associated with the participant. The behavioral engine may generate a reminder 408 associated with the upcoming task. The rendering engine of the communication application may present, on a display device 404, the reminder 408. In some embodiments, the rendering engine may detect a modification to the reminder 408. The modification to the reminder 408 may be saved at an isolated destination. In examples, the isolated destination may include a lock screen 406 of the computing device 402.

In some embodiments, the rendering engine may parse the reminder 408 to detect default attributes associated with the reminder 408. The default attributes may include the participant and/or a subject matter associated with the reminder 408, among others. The rendering engine may also receive a transmission input 412, detected on the display device 404, to transmit the reminder 408 to another destination. The other destination may include communications and/or calendar tasks of the participant, among others. In response to transmission input 412, the rendering engine may transmit the reminder 408 to the other destination.

In further embodiments, the rendering engine may parse the reminder 408 to detect social networking attributes associated with the reminder 408. The social networking attributes may include groups participated in by the participant and/or organizations supported by the participant, among others. The rendering engine may also receive the transmission input 412, detected on the display device 404, to transmit the reminder 408 to the other destination. The other destination may include a social networking site associated with the participant. The reminder 408 may be transmitted to the other destination.

In additional embodiments, the rendering engine may parse the reminder 408 to detect professional networking attributes associated with the reminder 408. The professional networking attributes may include a job title, an education, and/or work-related experience associated with the participant, among others. The rendering engine may receive the transmission input 412, detected on the display device 404, to transmit the reminder 408 to the other destination. The other destination may include a professional networking site associated with the participant. The reminder 408 may be transmitted to the other destination.

In some examples, the rendering engine may parse the reminder 408 to detect the default attributes, the professional networking attributes, and the social networking attributes associated with the reminder 408. The rendering engine may identify a weighted value associated with the default attributes. The rendering engine may also identify another weighted value associated with the professional networking attributes and the social networking attributes.

Next, the rendering engine may order the default attributes, the professional networking attributes, and the social networking attributes based on the weighted value and the other weighed value. The ordering may include one of a descending order or an ascending order, among other ordering schemes. The rendering engine may detect a customization input applied to the weighted value and/or the other weighed value. In response to the customization input, the rendering engine may re-order the default attributes, the professional networking attributes, and the social networking attributes based on the customization input.

Alternatively, the rendering engine may compare the weighed value and the other weighed value. The weighed value may be determined as larger than the other weighed value. Next, the rendering engine may receive the transmission input 412 to transmit the reminder 408 to the other destination. The other destination may include the communications and/or the calendar tasks of the participant. The rendering engine may transmit the reminder 408 to the other destination.

Furthermore, the rendering engine may identify the other weighted value as greater than the weighted value. Next, the rendering engine may receive the transmission input 412 to transmit the reminder 408 to the other destination. The other destination may include the professional networking site and the social networking site associated with the participant. The reminder 408 may be transmitted to the other destination.

In some examples, the communication application may provide the parsed attributes on a communication user interface (UI). The attributes may be listed in status columns hierarchically distinguished from the sub-attributes in the same column. The sub-attributes may include summary views of the attributes. An automatic mapping may be performed to translate the attribute fields to the status columns.

In other examples, the communication application may apply a filter during the process to map the parsed attributes to the columns. The filter may include rules, such as, “place default attributes in the first column.” A scheme may evaluate each of the attributes to detect the column in which the attributes fit based on the filter (rule or combination of rules). In response to the evaluation of the attributes, the communication application may move the attributes to the respective column. The fields and values associated with the attributes may be displayed visually on the communication UI. In some examples, the attributes may be displayed using graphical objects and/or textual identification. Some or all of displayed elements on the communication UI may be actionable.

In some embodiments, the communication application may provide a participant an access to control the reminder 408, information associated with the reminder 408, attributes extracted from the contextual data, and/or the tasks associated with the reminder 408. For example, the communication application may provide controls 410 (graphical and/or textual control elements) to allow the participant to perform actions on a selected reminder. The actions may include editing and copying the reminder 408, the information, the attributes, and/or the tasks. As updates and modifications are made to the reminder 408, the information, the attributes, and the tasks, updates may be transmitted to a communication data store.

The example scenarios and schemas in FIG. 1 through FIG. 4 are shown with specific components, data types, and configurations. Embodiments are not limited to systems according to these example configurations. Providing the reminder 408 related to contextual data on the lock screen 406 may be implemented in configurations employing fewer or additional components in applications and user interfaces. Furthermore, the example schema and components shown in FIG. 1 through FIG. 4 and their subcomponents may be implemented in a similar manner with other values using the principles described herein.

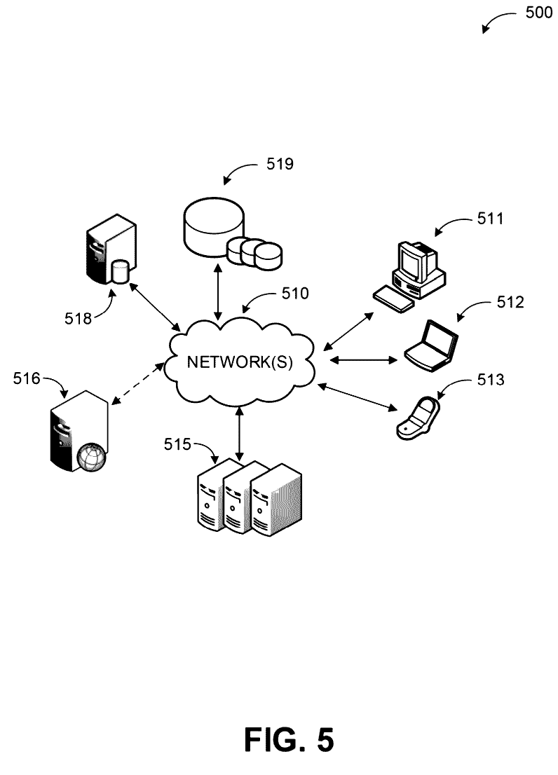

FIG. 5 is a simplified networked environment, where a system according to embodiments may be implemented.

As shown in a diagram 500, a computing device may execute a communication application. In examples, a communication service may be implemented via software executed over the servers 514. The platform may communicate with client applications on individual computing devices such as a smart phone 513, a mobile computer 512, or desktop computer 511 (‘client devices’) through network(s) 510. The servers 514 may include one or more communication servers 516, where at least one of the one or more communication servers 516 may be configured to execute one or more applications (e.g., the communication application) associated with the communication service.

In other examples, the communication service may be provided by a third party service or may include a web application. The communication service may store data associated with contextual data and reminder communications in a data store 519 directly or through a database server 518. Client applications executed on client devices 511-513 may be enabled to receive reminders associated with an upcoming task. The client applications executed on the client devices 511-513 may also be enabled to receive reminder data and render a communication interface displaying information associated with reminder.

Client applications executed on any of the client devices 511-513 may facilitate communications via application(s) executed by the one or more communication servers 516, or on an individual communication server. In an example scenario, a communication application may receive contextual data of a participant from a source associated with the participant. The contextual data may be analyzed to detect the upcoming task associated with the participant. A reminder associated with the upcoming task may be generated. Next, the reminder may be presented and a modification to the reminder may be detected. The modification to the reminder may be saved at an isolated destination. The communication application may store the reminder data associated with the reminder in the data store 519 directly or through database server 518.

The network(s) 510 may comprise any topology of servers, clients, Internet service providers, and communication media. A system according to embodiments may have a static or dynamic topology. The network(s) 510 may include secure networks such as an enterprise network, an unsecure network such as a wireless open network, or the Internet. The network(s) 510 may also coordinate communication over other networks such as Public Switched Telephone Network (PSTN) or cellular networks. Furthermore, the network(s) 510 may include short range wireless networks such as Bluetooth or similar ones. The network(s) 510 provide communication between the nodes described herein. By way of example, and not limitation, the network(s) 510 may include wireless media such as acoustic, RF, infrared and other wireless media.

A textual scheme, a graphical scheme, an audio scheme, an animation scheme, a coloring scheme, a highlighting scheme, and/or a shading scheme may be employed to further enhance participant interaction between the notification and the communication interface.

Many other configurations of computing devices, applications, data sources, and data distribution systems may be employed for providing a reminder related to contextual data on a lock screen Furthermore, the networked environments discussed in FIG. 5 are for illustration purposes only. Embodiments are not limited to the example applications, modules, or processes.

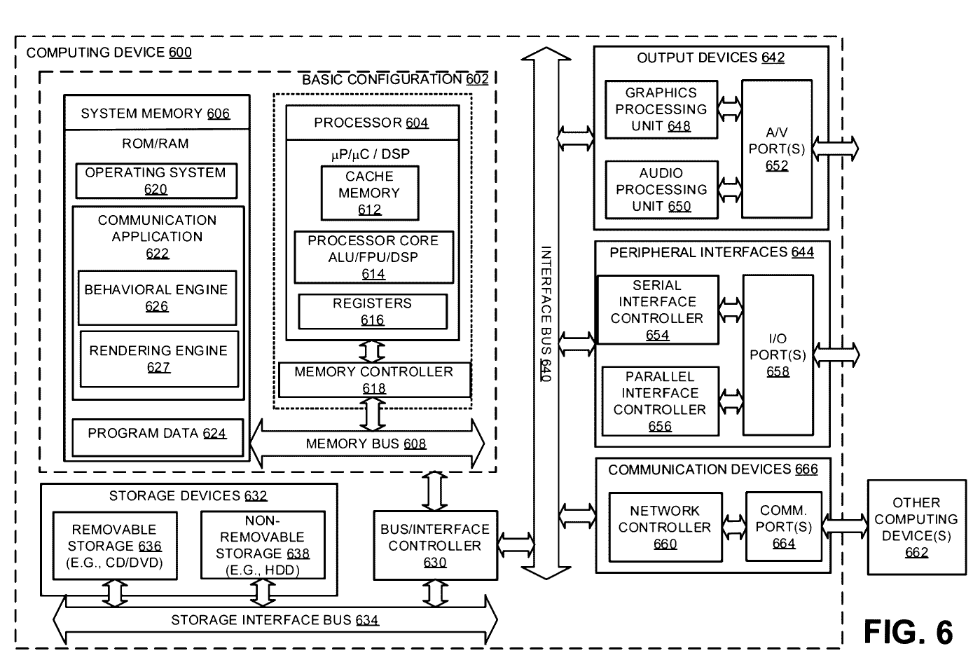

FIG. 6 is a block diagram of an example computing environment for providing a reminder related to contextual data on a lock screen, where embodiments may be implemented.

For example, a computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The example basic configuration 602 may be illustrated in FIG. 6 by those components within the inner dashed line.

Depending on the desired configuration, the processor 604 may be of any type, including but not limited to a microprocessor (imP), a microcontroller (tC), a digital signal processor (DSP), or any combination thereof. The processor 604 may include one more levels of caching, such as a level cache memory 612, one or more processor cores 614, and registers 616. The one or more processor cores 614 may (each) include an arithmetic logic unit (ALU), a floating point unit (FPU), a digital signal processing core (DSP Core), or any combination thereof. An example memory controller 618 may also be used with the processor 604, or in some implementations, the example memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a communication application 622, and a program data 624. The communication application 622 may include a behavioral engine 626 and a rendering engine 627.

The behavioral engine 626 may receive contextual data of a participant from a source associated with the participant. The source may include a directory service, an online service, and/or a local data source, among other examples. Next, the behavioral engine 626 may analyze the contextual data to detect an upcoming task associated with the participant and may generate the reminder associated with the upcoming task. The rendering engine 627 may present the reminder. The reminder may include a textual reminder, an audio reminder, a graphical reminder, and/or a feedback reminder, among other examples. The rendering engine 627 may also detect a modification to the reminder. Next, the modification may be saved at a destination.

In some examples, a networking device of the computing device 600 may provide communication between the communication application 622, other applications(s), other device(s), and/or other entities, among others. In other examples, components of the communication application 622 (such as a communication user interface (UI)) may also be displayed on a display device associated with the computing device 600. An example of the display device may include a hardware screen that may be communicatively coupled to the computing device 600. The display device may include a touch based device that detects gestures such as a touch action. The display device may also provide feedback in response to detected gestures (or any other form of input) by transforming the communication UI of the communication application 622, displayed by the touch based device. The program data 624 may also include, among other data, reminder data and information related to the reminders, or the like, as described herein.

The computing device 600 may have additional features or functionality, and additional interfaces to facilitate communications between the example basic configuration 602 and any desired devices and interfaces. For example, a bus/interface controller 630 may be used to facilitate communications between the example basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the example basic configuration 602 via the bus/interface controller 630. Some of the one or more output devices 642 include a graphics processing unit 648 and an audio processing unit 650, which may be configured to communicate to various external devices such as a display or speakers via one or more A/V ports 652. The one or more peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example communication device 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods for providing a reminder related to contextual data on a lock screen. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

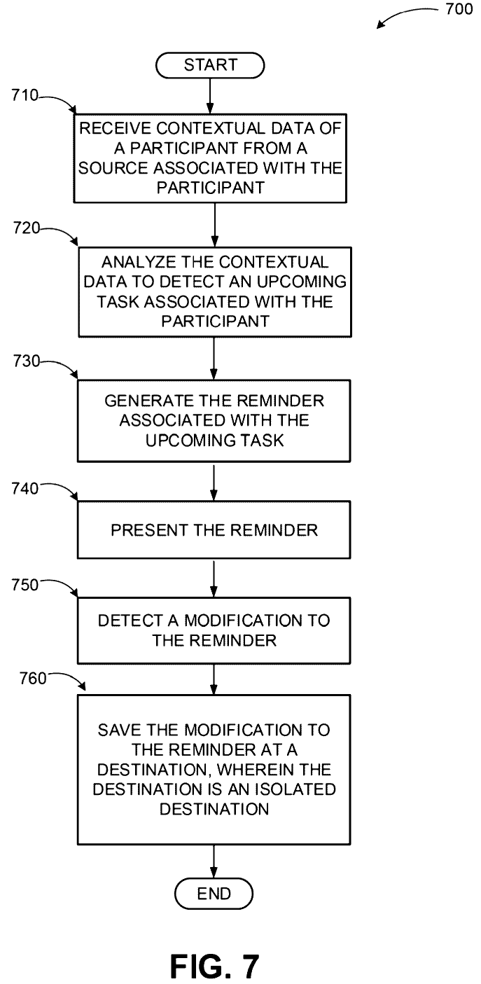

FIG. 7 illustrates a logic flow diagram for providing a reminder related to contextual data on a lock screen, according to embodiments.

A process 700 may be implemented on a computing device, such as the computing device 600, or with another system. As described, participants may be allowed to interact with a communication application through an input device or a touch enabled display component of the computing device 600. Components of the computing device 600 may (e.g., a communication user interface (UI)) may be displayed on a display device associated with the computing device.

The process 700 begins with operation 710, where the communication application may receive contextual data of a participant from a source associated with the participant. In examples, the contextual data may include organizational relationships associated with the participants, professional networking information, and/or social networking information associated with the participants, among others. The sources may include a directory service, an online service, and/or a local data source, among others.

At operation 720, the communication application may analyze the contextual data to detect an upcoming task associated with the participant. The analysis may include an extraction of information associated with the contextual data. The information may include textual information, audio information, graphical information, and/or Global Positioning Service (GPS) location information, among other types of information.

At operation 730, the communication application may generate the reminder associated with the upcoming task. The upcoming task may include a deadline associated with a meeting, a deadline associated with an event, an upcoming presentation, and/or an upcoming meeting, among others. At operation 740, the communication application may present the reminder. The reminder may include a textual reminder, an audio reminder, a graphical reminder, and/or a feedback reminder, among other examples.

At operation 750, the communication application may detect a modification to the reminder. At operation 760, the communication application may save the modification to the reminder at a destination. The destination may include an isolated destination.

The operations included in process 700 are for illustration purposes. Providing a reminder related to contextual data on a lock screen may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

A means for providing a reminder related to contextual data on a lock screen may be provided, which includes a means for receiving contextual data of a participant from a source associated with the participant, a means for analyzing the contextual data to detect an upcoming task associated with the participant, a means for generating the reminder associated with the upcoming task, a means for presenting the reminder, a means for detecting a modification to the reminder, and a means for saving the modification to the reminder at a destination. The source may include a directory service, an online service, or a local data source, among others. The destination may include an isolated destination.

According to some embodiments, computing devices for providing a reminder related to contextual data on a lock screen are described. An example computing device may include a display device, a memory, and processors coupled to the memory and the display device. The processors may execute a communication application in conjunction with instructions stored in the memory. The communication application may include a behavioral engine and a rendering engine. The behavioral engine may be configured to receive contextual data for a participant from a source associated with the participant, analyze the contextual data to detect an upcoming task associated with the participant, and generate the reminder associated with the upcoming task. The rendering engine may be configured to present, on the display device, the reminder. In other examples, the rendering engine may be further configured to detect a modification to the reminder and save the modification to the reminder at a destination. The destination may include an isolated destination.

According to other examples, the behavioral engine may be further configured to display, on the display device, a deadline associated with the reminder and distinguish the deadline with a textual scheme, a graphical scheme, an audio scheme, an animation scheme, a coloring scheme, a highlighting scheme, and/or a shading scheme, among others. In further examples, the behavioral engine may be further configured to display, on the display device, a summary information of an attachment associated with the reminder. The summary information may include a sender of the attachment, a time received associated with the attachment, and/or a title of the attachment, among others.

According to some examples, the behavioral engine may be further configured to analyze the contextual data by a process to extract information from the contextual data, identify a priority value associated with the GPS location information and another priority value associated with the textual information, and compare the priority value and the other priority value. The information may include textual information and/or Global Positioning Service (GPS) location information, among other examples. In other examples, the behavioral engine may be further configured to analyze the contextual data by a process to identify the priority value as larger than the other priority value and generate the reminder based on the GPS location information associated with the priority value.

According to other examples, the rendering engine may be further configured to parse the reminder to detect default attributes associated with the reminder. The default attributes may include the participant and/or a subject matter associated with the reminder, among others. The rendering engine may be further configured to receive a transmission input, detected on the display device, to transmit the reminder to another destination and transmit the reminder to the other destination. The other destination may include communications and/or calendar tasks of the participant, among others.

According to some examples, the behavioral engine may be further configured to parse the reminder to detect social networking attributes associated with the reminder, receive a transmission input to transmit the reminder to another destination, and transmit the reminder to the other destination. The social networking attributes may include groups participated in by the participant and/or organizations supported by the participant, among others. The other destination may include a social networking site associated with the participant.

According to further examples, the behavioral engine may be further configured to parse the reminder to detect professional networking attributes associated with the reminder, receive a transmission input to transmit the reminder to another destination, and transmit the reminder to the other destination. The professional networking attributes may include a job title, an education, and/or work-related experience associated with the participant, among others. The other destination may include a professional networking site associated with the participant.

According to other examples, the behavioral engine may be further configured to parse the reminder to detect default attributes, professional networking attributes, and social networking attributes associated with the reminder. The behavioral engine may be further configured to identify a weighted value associated with the default attributes and another weighted value associated with the professional networking attributes and the social networking attributes. In response, the behavioral engine may order the default attributes, the professional networking attributes, and the social networking attributes based on the weighted value and the other weighed value. The rendering engine may be further configured to detect a customization input applied to the weighted value and the other weighed value and re-order the default attributes, the professional networking attributes, and the social networking attributes based on the customization input.

According to some embodiments, methods executed on computing devices for providing a reminder related to contextual data on a lock screen, may be provided. An example method may include process steps, such as, receiving contextual data of a participant from a source associated with the participant, analyzing the contextual data to detect an upcoming task associated with the participant, generating the reminder associated with the upcoming task, presenting the reminder, detecting a modification to the reminder, and saving the modification to the reminder at a destination. The source may include a directory service, an online service, or a local data source, among others. The destination may include an isolated destination.

According to other examples, the method may include further process steps for extracting information from the contextual data, identifying a priority value associated with the audio information and another priority value associated with the graphical information, and comparing the priority value and the other priority value. The information may include audio information and/or graphical information, among other examples. In further examples, the method may further include process steps for identifying the priority value as larger than the other priority value and generating the reminder based on the audio information associated with the priority value. The reminder may include a textual reminder, an audio reminder, a graphical reminder, and/or a feedback reminder, among others.

According to some examples, the method may further include process steps for parsing the reminder to detect default attributes, professional networking attributes, and social networking attributes associated with the reminder. The method may further include process steps for identifying a weighted value associated with the default attributes and another weighted value associated with the professional networking attributes and the social networking attributes and comparing the weighed value and the other weighed value. In some examples, the method may further include process steps for identifying the weighted value as larger than the other weighted value, receiving a transmission input to transmit the reminder to another destination, wherein the other destination includes one or more communications and one or more calendar tasks of the participant, and transmitting the reminder to the other destination. In further examples, the method may further include process steps for identifying the other weighted value as greater than the weighted value, receiving a transmission input to transmit the reminder to another destination, wherein the other destination includes a professional networking site and a social networking site associated with the participant, and transmitting the reminder to the other destination.

According to some examples, computer-readable memory devices with instructions stored thereon for providing a reminder related to contextual data on a lock screen may be provided. An example computer-readable memory device with instructions stored thereon for providing a reminder related to contextual data on a lock screen may include receiving contextual data of a participant from a source associated with the participant, analyzing the contextual data to detect an upcoming task associated with the participant, generating the reminder associated with the upcoming task, presenting the reminder, detecting a modification to the reminder, and saving the modification to the reminder at a destination. The source may include a directory service, an online service, or a local data source, among others. The destination may include an isolated destination.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device for providing a reminder related to contextual data on a lock screen, the computing device comprising:
a display device;
a memory; and
one or more processors coupled to the memory and the display device, the one or more processors executing a communication application in conjunction with instructions stored in the memory, wherein the communication application includes:
a behavioral engine configured to:
receive contextual data for a participant from a source associated with the participant;
analyze the contextual data to detect an upcoming task associated with the participant; and
generate the reminder associated with the upcoming task; and
a rendering engine configured to:
present, on the display device, the reminder;
detect a modification to the reminder; and
save the modification to the reminder at a destination, wherein the destination is an isolated destination.

2. The computing device of claim 1, wherein the behavioral engine is further configured to:
display, on the display device, a deadline associated with the reminder; and
distinguish the deadline with one or more of a textual scheme, a graphical scheme, an audio scheme, an animation scheme, a coloring scheme, a highlighting scheme, and a shading scheme.

3. The computing device of claim 1, wherein the behavioral engine is further configured to:
display, on the display device, a summary information of an attachment associated with the reminder, wherein the summary information includes one or more of: a sender of the attachment, a time received associated with the attachment, and a title of the attachment.

4. The computing device of claim 1, wherein analyzing the contextual data includes a process to:
extract information from the contextual data, wherein the information includes textual information and Global Positioning Service (GPS) location information;
identify a priority value associated with the GPS location information and another priority value associated with the textual information; and
compare the priority value and the other priority value.

5. The computing device of claim 4, wherein analyzing the contextual data includes a process to:
identify the priority value as larger than the other priority value; and
generate the reminder based on the GPS location information associated with the priority value.

6. The computing device of claim 1, wherein the rendering engine is further configured to:
parse the reminder to detect default attributes associated with the reminder, wherein the default attributes include the participant and a subject matter associated with the reminder;
receive a transmission input, detected on the display device, to transmit the reminder to another destination, wherein the other destination includes one or more communications and one or more calendar tasks of the participant; and
transmit the reminder to the other destination.

7. The computing device of claim 1, wherein the behavioral engine is further configured to:
parse the reminder to detect social networking attributes associated with the reminder, wherein the social networking attributes include one or more groups participated in by the participant and organizations supported by the participant;
receive a transmission input to transmit the reminder to another destination, wherein the other destination includes a social networking site associated with the participant; and
transmit the reminder to the other destination.

8. The computing device of claim 1, wherein the behavioral engine is further configured to:
parse the reminder to detect professional networking attributes associated with the reminder, wherein the professional networking attributes include one or more of a job title, an education, and work-related experience associated with the participant;
receive a transmission input to transmit the reminder to another destination, wherein the other destination includes a professional networking site associated with the participant; and
transmit the reminder to the other destination.

9. The computing device of claim 1, wherein the behavioral engine is further configured to:
parse the reminder to detect default attributes, professional networking attributes, and social networking attributes associated with the reminder;
identify a weighted value associated with the default attributes and another weighted value associated with the professional networking attributes and the social networking attributes; and
order the default attributes, the professional networking attributes, and the social networking attributes based on the weighted value and the other weighed value.

10. The computing device of claim 9, wherein the rendering engine is further configured to:
detect a customization input applied to one or more of the weighted value and the other weighed value; and
re-order the one or more default attributes, the one or more professional networking attributes, and the one or more social networking attributes based on the customization input.

11. A method for providing a reminder related to contextual data on a lock screen, the method comprising:
receiving contextual data of a participant from a source associated with the participant, wherein the source includes one or more of a directory service, an online service, and a local data source;
analyzing the contextual data to detect an upcoming task associated with the participant;
generating the reminder associated with the upcoming task;
presenting the reminder;
detecting a modification to the reminder; and
saving the modification to the reminder at a destination, wherein the destination is an isolated destination.

12. The method of claim 11, further comprising:
extracting information from the contextual data, wherein the information includes audio information and graphical information;
identifying a priority value associated with the audio information and another priority value associated with the graphical information; and
comparing the priority value and the other priority value.

13. The method of claim 12, further comprising:
identifying the priority value as larger than the other priority value; and
generating the reminder based on the audio information associated with the priority value.

14. The method of claim 11, further comprising:
parsing the reminder to detect default attributes, professional networking attributes, and social networking attributes associated with the reminder;
identifying a weighted value associated with the default attributes and another weighted value associated with the professional networking attributes and the social networking attributes; and
comparing the weighed value and the other weighed value.

15. The method of claim 14, further comprising:
identifying the weighted value as larger than the other weighted value;
receiving a transmission input to transmit the reminder to another destination, wherein the other destination includes one or more communications and one or more calendar tasks of the participant; and
transmitting the reminder to the other destination.

16. The method of claim 14, further comprising:
identifying the other weighted value as greater than the weighted value;
receiving a transmission input to transmit the reminder to another destination, wherein the other destination includes a professional networking site and a social networking site associated with the participant; and
transmitting the reminder to the other destination.

17. The method of claim 11, wherein the reminder includes one or more of: a textual reminder, an audio reminder, a graphical reminder, and a feedback reminder.

18. A computer-readable memory device with instructions stored thereon for providing a reminder related to contextual data on a lock screen, the instructions comprising:
receiving contextual data of a participant from a source associated with the participant, wherein the source includes one or more of a directory service, an online service, and a local data source;
analyzing the contextual data to detect an upcoming task associated with the participant;
generating the reminder associated with the upcoming task;
presenting the reminder;
detecting a modification to the reminder, and
saving the modification to the reminder at a destination, wherein the destination is an isolated destination.

19. The computer-readable memory device of claim 18, wherein the instructions further comprise:
extracting information from the contextual data, wherein the information includes textual information, audio information, graphical information, and Global Positioning Service (GPS) location information;
identifying a priority value associated with the audio information and another priority value associated with the graphical information;
comparing the priority value and the other priority value;
identifying the priority value as larger than the other priority value; and
generating the reminder based on the audio information associated with the priority value.

20. The computer-readable memory device of claim 19, wherein the instructions further comprise:
parsing the reminder to detect default attributes, professional networking attributes, and social networking attributes associated with the reminder;
identifying a weighted value associated with the default attributes and another weighted value associated with the professional networking attributes and the social networking attributes;
comparing the weighed value and the other weighed value;
identifying the weighted value as larger than the other weighted value;
receiving a transmission input to transmit the reminder to another destination, wherein the other destination includes one or more communications and one or more calendar tasks of the participant; and
transmitting the reminder to the other destination.
